(19) United States
(12) Patent Application Publication
(10) Pub. No.: US 2010/0220369 A1
(43) Pub. Date: Sep. 2, 2010

(54) Scanning System for Scanning an Object Surface, in Particular for a Coordinates Measurement Machine

(76) Inventor: Alexander Knüttel, Birkenau (DE)

Correspondence Address: Walter A Hackler;Patent Law Office, 2372 S E Bristol Street, Suite B, Newport Beach, CA, 92660-0755, US

(21) Appl. No.: 12/086,527

(22) PCT Filed: Dec. 2, 2006
(86) PCT No.: PCT/EP2006/011586

§ 371 Date: Jun. 13, 2008

(30) Foreign Application Priority Data
Dec. 23, 2005 (DE) 102005062130.9

(51) Int. Cl. H04N 1/04

(52) U.S. Cl. 358/475; 358/493

(57) ABSTRACT

Scanning system for scanning the surface (13, 14) of an object, in particular for a coordinates measurement machine. A scan sensor (1) comprises at least one fluid-mounted light transport module (2), a fluid being located between the light transport module (2) and a bearing part (3) in a bearing gap (7), by means of which fluid the light transport module (2) is mounted in such a manner that it is movable both axially and also rotating in relation to the axis of the cylindrical external wall. Primary light originating from a light source is transported through the interior (8) of the light transport module (2) to a primary exit point (12a, 12b) distal in the axial direction, from which it is emitted in the direction toward the object surface (13, 14). Secondary light reflected from the object surface (13, 14) is also transported through the interior (8) of the light transport module (2) to a secondary light exit point (17) distal in the axial direction from the secondary light entry point (16a, 16b). The light transport module is drivable both in the axial direction and also rotating by means of a rotation-translation drive (27).

Numerous fields of application require high precision scanning of the surface of an object. The term “to scan” is generally to be understood as referring to any method in which a plurality of measuring points are detected on a surface to obtain information about its shape in space. In particular, the determination of the exact dimensions of an object (“dimensional examination”) is important, but also determination of the structural properties of the surface, i.e., its roughness, for example.

The scanning system according to the invention is in particular suitable as a so-called “scan sensor” for coordinates measurement machines, which are used, for example, in industrial manufacturing operations, but also in laboratories for dimensional examination, including detecting surface structures and structural defects. Such coordinates measurement machines have a multidimensional high-precision drive, by means of which a scan sensor is moved in relation to the examined object while its surface is scanned by the scan sensor. Another important area of application is positioning robots.

Primarily mechanical scanners are used as scan sensors. These contact the measured object by means of a thin tip or small sphere. This contact is detected by electronic means. With high effort, very good precision down into the sub-μm range can be achieved with mechanical scanners, but the required contact with the measuring objects is connected with significant disadvantages. On one hand the scanning speed is low and thus the total measuring time is high, and on the other hand damage or measurement value deviations are unavoidable on sensitive or elastic surfaces.

Contactless scan sensors are typically based on image processing technology. The measured object is illuminated by means of special illumination technologies (dark field, bright field, transmitted light) and observed by means of video technology. The results are analyzed using image processing software and converted into the desired dimensional information. However, this technology is only suitable for specific objects and requires large and complex sensors.

Other sensors operating by optical means are also used for special purposes, such as laser distance sensors, which are especially recommended for the rapid measurement of the planarity of a measured object and for measuring slightly curved free-form surfaces, or glass fiber sensors comprising very fine glass fibers whose bending upon contacting the surface is optically observed.

### SUMMARY OF THE INVENTION

On this basis, the invention addresses the technical problem of providing a compact, very precise, rapid, and cost-effectively producible scanning system.

The technical problem is solved by a scanning system for scanning the surface of an object, in particular for dimensional examination, primarily in connection with a coordinates measurement machine, the system comprising a scan sensor which includes a least one fluid-mounted light transport module, the light transport module being enclosed by a bearing part and a fluid being located between the external wall and the bearing part in a bearing gap, by means of which fluid the light transport module is mounted in such a manner that it is movable both axially and also rotating in relation to the axis of the cylindrical external wall, primary light originating from a light source and entering at a primary light entry point into the light transport module is transported through the interior of the light transport module to a primary light exit point distal in the axial direction from the primary light entry point, from which it is emitted in the direction toward the object surface and secondary light reflected from the object surface, which enters the light transport module at a secondary light entry point preferably coinciding with the primary light exit point (12a, 12b) is also transported through the interior of the light transport module to a secondary light exit point which is distal in the axial direction from the secondary light entry point and preferably corresponds to the primary light entry point, and the light transport module can be driven by means of a rotation-translation drive (preferably fastened to the bearing part) both in the axial direction and also rotating. The light originating from the light source of the optical measuring configuration is designated here as primary light, and the light reflected on the object or a reference reflector as secondary light.

The optical scan sensor used in the invention, comprising at least one fluid-mounted light transport module, allows the integration of the functional components required, on one hand for the light transport (optics), and on the other hand for the scanning movement (actuators), in a very small space and with a very small moved mass. The invention is thus in principle suitable for various optical measurement methods. For example, a confocal measurement configuration may be used, in which focused light is emitted from the light transport module, and focused detection is used, to allow differentiation in the radiation direction (“longitudinal scan”) by variation of the focusing.

In particular, the invention is suitable for scanning by means of a low coherence interferometer configuration. In general, low coherence interferometers (also called “white light interferometers”) are used for light-optic scanning by detecting the position of light-remitting points, which are localized at different distances from the device along a path running in the scanning direction (i.e., in the direction of the detecting light beam; longitudinal scan). This method is also designated as a “low coherence distance scan (LCDS)”.

All LCDS methods share the feature that light of a low coherence light source (i.e., broadband spectral emission) is divided into two light paths, namely a measurement light path, which is radiated onto the measured object, and a reference light path. The two partial light paths are united before the incidence on a detector in such a manner that they interfere with one another. For this purpose, the interferometer configuration typically comprises (at least one) beam splitter, a reference reflector, and the detector in addition to the low coherence light source. The light paths between these elements form interferometer arms. The primary light is transported from the light source to the beam splitter through a light source arm and is divided there. A first component of the primary light is radiated as measurement light via an object arm in the scanning direction onto the object, while a second component of the primary light is transported to the reference reflector as reference light via a reflector arm. Both light components are reflected (the measurement light at light reflecting points of the examined object, the reference light at the reference reflector). After the reflection they are returned as secondary light on the same respective light path (object arm or reference arm) to the beam splitter. The secondary light components are combined there and radiated as detection light via a detection arm to the detector. According to a preferred embodiment of the present invention, a partial path of the measurement light path and preferably also a partial path of the reference light path run within at least one fluid-mounted light transport module.

The longitudinal scan position is varied rapidly during the scanning. This is typically performed by changing the relation of the lengths of the reference light path and the measurement light path. Thereby the position at the scanning path is changed, for which the condition for interference of the measurement light and the reference light (namely, that the optical path lengths of both light paths deviate from one another by not more than the coherence length of the light) is fulfilled. The momentary scanning position is the position on the scanning path for which, in the particular interferometer configuration, the optical length of the total measurement light path is the same as the optical length of the total reference light path (“coherence condition”). Typically, the reference mirror is shifted in the direction of the reference beam and the length of the reference light path is thus reduced or increased.

More specific details about various previously known LCDS devices and methods may be taken from the relevant literature. Reference is made in particular to WO 03/073041 and the further publications 1) through 6) cited therein. WO 03/073041 is in particular concerned with a special LCDS method allowing extremely rapid longitudinal scan which can not be achieved by shifting a reference mirror. This special method is also preferably used in the context of the present invention, but other previously known interferometer configurations can also be used in connection with the present invention. Examples are described in DE 19819762 and in the publication citations of WO 03/073041.

For the fluid mounting of the at least one light transport module according to the invention a liquid or a gas is suitable as the fluid. Preferably the bearing medium used for the mounting is a gas, in particular air. Air is referred to hereafter as the fluid used for the mounting, without restriction of the generality. The air bearing is based on air being pressed, with the aid of an external compressed air source, into a bearing gap between the light transport module and the bearing part. It is preferably delimited on one side by the external wall of a cylindrical bearing section of the light transport module and on the other side by the internal wall of the bearing part, which faces toward the bearing section of the light transport module. The air pressure must be high enough to avoid, by the air cushion formed between the bearing surfaces, any contact of the bearing surfaces under the forces occurring in operation of the scanning system.

According to a preferred embodiment, the scan sensor comprises two light transport elements, which are both fluid-mounted, preferably within a shared bearing part. The mounting is not necessarily provided by means of a single bearing gap. Rather, the invention also comprises embodiments in which a second light transport module penetrates telescopically at least partially into a corresponding recess of the first light transport module and is fluid-mounted there in a bearing gap between both light transport modules. In this case, the fluid mounting at least partially does not occur directly between the bearing part and the light transport module, but rather indirectly via the first light transport module.

In mechanical engineering air bearings are mainly used for the bearing of shafts which rotate at extremely high speeds (cf., for example, DE 102 10 750 B4). Comparably high speeds are not used in the context of the present invention. Also, the practical freedom from friction provided by air bearings is not of primary importance. Rather, the invention makes use of the property of an air bearing (or other fluid bearing) that, by means of the same bearing elements, it allows a “real” two-dimensionally unrestricted axial mobility and rotation by means of a single bearing. In order to allow these two degrees of freedom of movement in practice by means of roller bearings, separate axial and rotation bearings must be employed. A bearing which allows a longitudinal displacement, in addition to the rotation, of a (cylindrical) shaft is designated in mechanical engineering also as a “floating bearing”.

In the context of the invention, such a bearing is combined with a rotation-translation drive, which is adapted to move the fluid-mounted light transport module both rotating and also in the axial direction. The rotation-translation drive is preferably fixed to the bearing part. Basically, various drive concepts are usable, such as (contactlessly operating) electromagnetic drives. A preferred drive operates by means of transport elements which are intermittently pressed against the wall of the light transport module in the bearing section and execute step-by-step movements tangentially to the wall surface in such a manner that the light transport module is moved in the desired direction. A drive in which the transport elements are moved piezoelectrically is especially preferred.

Piezoelectric drives, which are also designated as “piezomotors”, have at least one leg which comprises a plurality of piezoceramic layers stacked one on top of another, a conductive material being located between the layers. A synchronous movement of the legs is achieved by means of a controlled electrical field. Such movement is suitable to cause a step-by-step advancement of an adjacent surface. Although the length of the individual steps is typically a few micrometers, speeds of a plurality of centimeters/second can be achieved at frequencies of a plurality of tens of thousands of steps per second. Piezomotors of this type are produced, for example, by Piezomotor Uppsala AB, Sweden.

A piezoelectric actuator which, in adapted form, is also applicable for the present invention is described in DE 19961684 A1. So-called “coupled resonance piezomotors (CRP)” are used therein. The piezomotors are operated in types of operation which may also be used in the context of the present invention as follows:
In a first type of operation, the force transmission occurs in the tangential direction, which drives the desired axial and/or rotating movement of the light transport module.
In a second type of operation, the transport elements (legs) of the piezomotor are set into longitudinal oscillations, by which the friction between the transport elements and the bearing section of a light transport module is minimized. This operation state is used to achieve minimum obstruction of a movement of the light transport module, which is driven by another piezomotor.
In a third operating state, the piezoelectric excitation of the transport elements is shut off. In this state, the friction between the transport elements and the external wall of the bearing section prevents unintentional changes of the position of the light transport module. The drive is thus self-locking.

DE 19961684 A1 explains that piezoelectric actuators allow a continuous and well-controllable rotational movement and require very little maintenance. On the other hand, it is seen as a disadvantage, that they require a certain contact pressure force, because the force required for the movement is transmitted by friction between the transport elements and the object. However, it has been established in the context of the invention that such a drive is very well suitable in combination with the fluid mounting for an optical scanning system according to the invention.

The following advantages are achieved, inter alia, by the invention:
The scanning of a surface may be performed at very much higher speed than by means of mechanical scanners.
The surface is not contacted and therefore may not be damaged.
Even if the surface of the object is deformable (elastic), the measurement precision is not negatively influenced thereby.
The optical detection spot may be focused to be extremely small. Therefore small local changes (e.g., depressions) may still be scanned, whose scanning is not possible by to means of the typical mechanical scanners.
Mechanical scanners comprising very small measurement tips are available, which may also scan very fine structures and surface roughnesses. However, this must be performed very slowly, while the scanning by a system according to the invention may be performed much more rapidly at comparable resolution.

### BRIEF DESCRIPTION OF THE DRAWINGS

The invention is explained in greater detail hereafter on the basis of exemplary embodiments shown in the figures. The special features shown and described may be used individually or in combination to provide preferred embodiments of the invention. In the figures:

FIG. 1 shows a very schematic side view of a scan sensor for a scanning system according to the invention;

FIG. 2 shows a very schematic side view, partially as a block diagram, of a scanning system according to the invention comprising a second embodiment of a scan sensor;

FIG. 3 shows a very schematic side view of a third embodiment of a scan sensor;

FIG. 4 shows a very schematic side view of a fourth embodiment of a scan sensor;

FIG. 5 through FIG. 7 show schematic side views of three different light exit optics modules.

### DETAILED DESCRIPTION

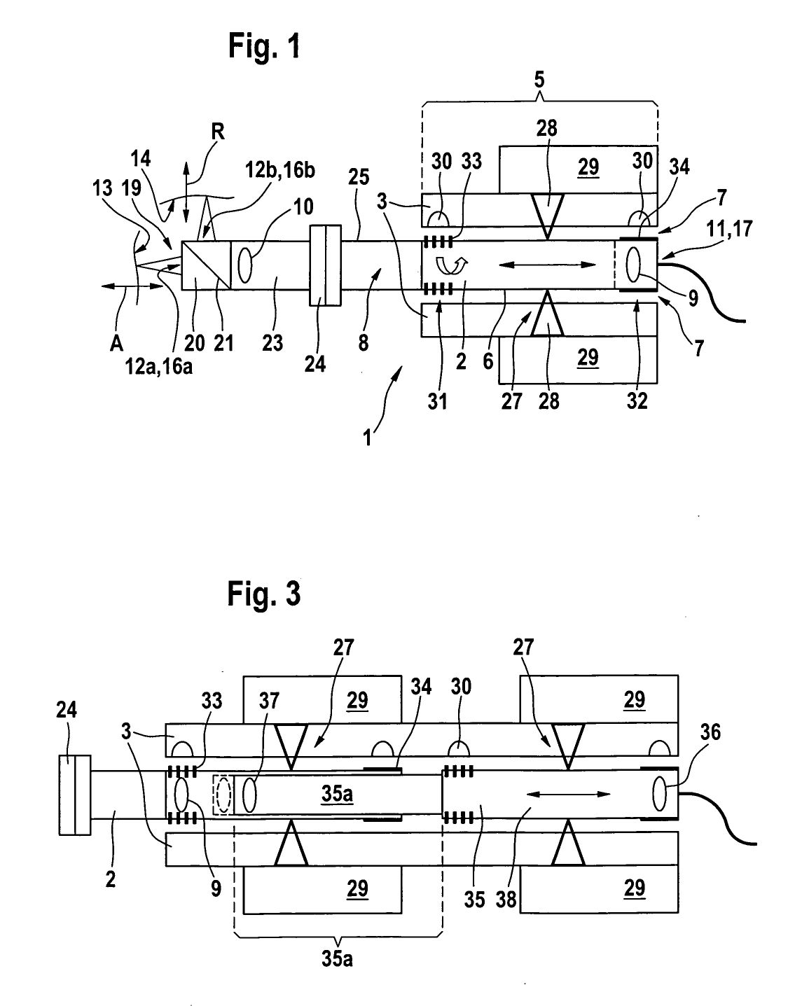

The scan sensor 1 shown in FIG. 1 comprises an elongate light transport module 2, which is air-mounted by means of a bearing part 3. The light transport module 2 is enclosed, at least in a bearing section 5, by a cylindrical external wall 6, which is in turn enclosed by the bearing part 3 in such a manner that a bearing gap 7 is present therebetween. Air is pressed into the gap by a compressed air source (not shown). Of course, the designs of the bearing section 5 and of the bearing part 3 as well as the pressure of the air pressed into the air gap 7 must be adapted to one another in such a manner that the light transport module 2 is mounted contactlessly within the entire desired movement range and at any load occurring in operation. It is in principle sufficient if the light transport module 2 has one or more cylindrical bearing sections extending a relatively short distance in the axial direction, provided their length is sufficient to ensure the desired axial mobility. However, at least that partial lengths of the light transport module 2, which during at least a part of the operation of the scan sensor is located inside the bearing part 3, is preferably cylindrical.

The light transport module 2 contains, in its interior 8, an optical system comprising elements of free space optics, in particular lenses 9, 10, through which the primary light is transported from a light entry point 11 to a light exit point 12 axially distal therefrom. In the embodiment shown there are two light exit points 12a and 12b, from which the primary light is emitted on one hand in the axial direction and on the other hand in the radial direction onto an object surface 13, 14. Secondary light reflected from the object surface 13 and/or 14 reenters into the elongate light transport module 2 at a secondary light entry point 16a, 16b, coinciding in the present case with the respective light exit point 12a, 12b, and is conducted by the optical system in its interior 8 to a secondary light exit point 17, which coincides in the present case with the primary light entry point 11.

Light exit optics 19 are used for emitting the primary light, which in the present case comprise a prism 20 comprising a preferably wavelength-dependent beam splitter layer 21. The light is divided by the beam splitter layer 21 in the axial (light exit point 12a) and radial (light exit point 12b) spatial directions, to allow on one hand scanning of an object surface 13 located in front of the light transport module 2 in the axial direction and on the other hand of an object surface 14 located laterally from the light transport module 2 in the radial direction.

Of course, it may be expedient in specific applications to use only one of these possibilities and to omit the beam splitter 21 (axial scanning) or replace it with a surface which reflects as completely as possible (radial scan). However, the scan sensor 1 preferably allows both scanning directions simultaneously. The light components can be separated in a known way. In the case shown, the separation is performed by means of the wavelength-dependent beam splitter layer in combination with different primary light wavelengths for the radial and axial scanning.

In the preferred embodiment shown, the light exit optics 19 are not implemented integrally with the remaining light transport module 2, but rather as a component of an exit optics module 23, which may be connected interchangeably, by means of a coupling 24, to a scanning module base part 25, which in particular comprises the bearing section 5 and preferably contains all remaining parts of the light transport module

The light transport module 2 can be driven in the bearing part 3 both in the axial direction and also rotating, by means of a rotation-translation drive 27. The drive is preferably fastened to the bearing part 3 and acts on the light transport module 2.

As explained, a drive is preferably used which, by means of transport elements 28 symbolically shown in the figures, intermittently presses against the wall 8 in the bearing section 5, the transport elements 28 executing step-by-step movements tangentially to the wall surface in such a manner that the light transport module 2 is moved in the desired direction. The transport elements 28 are preferably moved piezoelectrically by means of a piezo drive electronics 29.

Preferably separate transport elements 28 are provided for the axial movement and for the rotating movement. The transport elements perform tangential movements in the corresponding spatial directions (in the axial direction or transversely thereto) when the corresponding axial or rotating movement is desired. Preferably, during a rotational movement the axially acting transport elements are in an operating state (such as the second operating state explained above) in which the rotational movement is obstructed as little as possible. Of course, this is reversed in case of an axial movement, i.e., the transport elements 28 responsible for the rotation are in an operating state which obstructs the axial movement as little as possible.

According to a further preferred embodiment, local distribution of the transport elements 28 on the bearing part 3 enclosing the bearing section 5 is such, that the forces exerted by them on the wall 6 essentially cancel out mutually. In any case, their force effects are to compensate for one another in such a manner that no radial movement of the bearing section 5, and thus of the light transport module 2, which would interfere with the scanning, is caused by the pressure of the transport elements 28 (“compensation condition”). In the simplest case, the transport elements are therefore positioned in pairs in such a manner that they press against the wall 8 of the bearing section 5 of the light transport module 2 from opposing peripheral positions, but in identical axial position. Other designs are possible, for example, comprising three, four, or more transport elements distributed uniformly on the circumference (i.e., at angle intervals of 120°, 90°, . . . ). However, a plurality of transport elements acting in identical or in different directions (each extending from the bearing part 3) can be provided for acting on the external wall 6 in the bearing section 5 over the length of the scanning distance, wherein preferably the above-mentioned compensation condition is always maintained. Maintaining the compensation condition not only avoids negative effects on the optical measurement by incorrect positioning of the light transport module, but also provides improved effectiveness of the transport elements at relatively low contact pressure force.

To ensure precise information about the axial position and also the rotational angle position of the light transport module 2 at all times, an axial position sensor 31 and a rotational position sensor 32 are provided. Each of the sensors 31, 32 works with a position marking 33 or 34, respectively, which is attached to the light transport module 2. Suitable position sensors and rotational angle sensors are known in numerous embodiments. In particular, optical positional and rotational angle sensors are suitable in the context of the invention, in which the position marking comprises a series of marks positioned at close intervals (typically periodically), such as very fine dashes or scratches. They are detected by means of a light-optic sensor 30 fastened to the bearing part and the resulting signal sequences are processed by means of a processor into the desired positional information. A more detailed explanation is not necessary, because these methods are known.

The field of application of the scan sensor 1 shown in FIG. 1 is restricted in two regards:
Firstly, a rotating movement of the light transport module 2 is only possible insofar as the means by which the primary light is fed to the light entry point 11 and the secondary light is led away from the light exit point 17, are suitable to follow such a rotation. These means preferably comprise optical fibers. Therefore only limited rotation is possible.
Secondly, the focusing is fixed, so that in the axial and also in the radial direction scanning in the beam direction (longitudinal scan, symbolized by the arrows A and R) is only possible in a narrow depth of field range around the focal point. This problem is less severe for axial scanning, because a longitudinal scan in the A direction may be effected by axial displacement of the light transport module. However, a longitudinal scan in the R direction would require a corresponding sideways movement of the entire scan sensor 1. This contradicts the requirement for very rapid scanning, in which the mass of the moved device should be as small as possible.

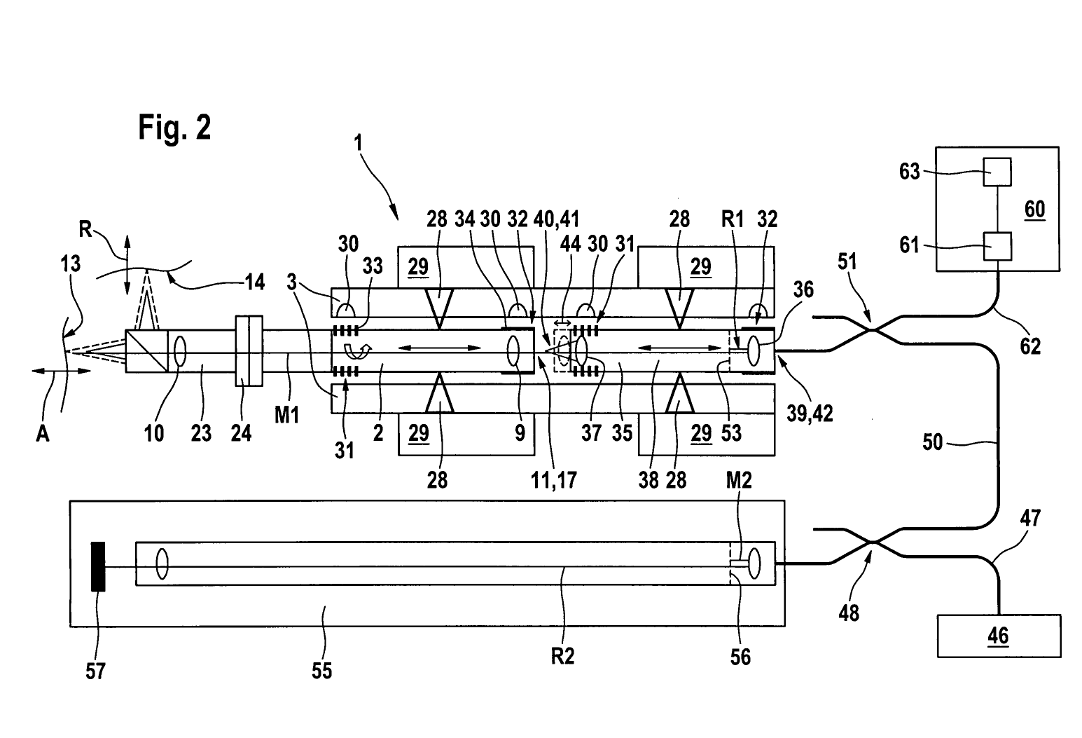

This problem is solved by the design shown in FIG. 2, in which identical or corresponding components are identified by the same reference signs as in FIG. 1. A special feature of the scan sensor 1 of FIG. 2 in comparison to FIG. 1 is that it has a further fluid-mounted light transport module, which is designated as the longitudinal-scan module 35. It is guided precisely coaxially to the light transport module 2 in such a manner that it is movable in the same axial direction. It contains optical elements, such as lenses 36 and 37, through which the primary light is transported from a primary light entry point 39 through the interior 38 of the longitudinal-scan module 35 to a primary light exit point 40 of the longitudinal-scan module 35 distal in the axial direction, from which it is relayed to the primary light entry point 11 of the first light transport module 2. In addition, secondary light is also transported to the interior 38 of the longitudinal-scan module 35, which reaches the interior 38 from the primary light exit point 17 of the first light transport module 2 via a secondary light entry point 41 preferably coinciding with the primary light exit point 40 of the longitudinal-scan module 35 and is transported therein to a secondary light exit point 42 of the longitudinal-scan module 35 distal in the axial direction, this in turn coinciding with the primary light entry point 39.

The longitudinal-scan module 35 is preferably mounted together with the first light transport module 2, i.e., the bearing section of the light transport module 2 and the longitudinal-scan module 35 (in any case at least a partial section of its length [bearing section]) are, as shown in FIG. 2, enclosed by a common bearing part (in particular in a shared cylindrical tube) and thereby precisely coaxially guided.

The movements of the longitudinal-scan module 35 required for scanning are preferably driven, like the movements of the first light transport module 2, by transport elements 28, which are intermittently pressed against its wall and execute step-by-step movements tangentially to the wall surface in such a manner that the longitudinal-scan module is moved in the desired direction. The explanations given for the first light transport module also apply correspondingly in regard to preferred designs, i.e.,
the transport elements are piezoelectrically moved
their positioning follows the compensation condition explained above
the axial position and the rotational position may be detected precisely at any time by means of an axial position sensor 31 and a rotational position sensor 32 (comprising the features explained above)

In operation a rotating and (if desired) axial scan is preferably performed by means of the light transport module 2 and the longitudinal scan is performed by means of the longitudinal-scan module 35:
The rotation of the light transport module 2 is not restricted by an attached optical fiber, because the primary and/or secondary light is coupled in and out by means of free space optics. Accordingly, for example, a constant rotation of the light transport module 2 in one rotational direction is possible. In combination with a simultaneous slow change of the axial position of the light transport module 2, helical scanning results, which is advantageous for many applications. In general, the embodiment described here allows very rapid and precise scanning of surfaces which surround the first light transport module 2 rotationally symmetrically, such as holes of machine parts.
By shifting the longitudinal-scan module 35 in the axial direction (indicated by the double arrow 44), the scanning position is correspondingly varied in the beam direction according to arrows A and R. With respect to the axial longitudinal scan A this is also possible by means of a simple light transport module according to FIG. 1. However, the use of a separate longitudinal-scan module is advantageous because a very much smaller mass has to be moved. Furthermore, with the configuration of FIG. 2 a significantly wider scanning range is possible for a longitudinal scan in the radial direction R, because the focal point is varied according to the change of the position of the longitudinal-scan module 35 in the direction of the double arrow R. The radial scan is thus only restricted by limits which result from the optical boundary conditions of the free space optics system in the light transport module 2 and in the longitudinal-scan module 35. In consideration of these restrictions longitudinal scanning path lengths of at least 5 mm can be provided.

FIG. 2 shows schematically the further components of a preferred optical scanning system, which comprises, in addition to the scan sensor 1, further components of a low coherence interferometer 45. These include a light source 46, from which primary light is transported via a light source arm 47, implemented by means of optical fibers, to a first optical coupler 48. From there, a part of the primary light reaches the primary light entry point 39 of the longitudinal-scan module 35 via a connection section 50 and a second optical coupler 51

A special feature of the shown interferometer configuration is that a partial path of the reference light path identified by R1 runs in a fluid-mounted light transport module (in the longitudinal-scan module 35 in FIG. 2 and in the light transport module 2 in FIG. 1). This is the partial path between the primary light entry point 39 (FIG. 2) or 11 (FIG. 1) and a beam splitter plate used as the reference reflector 53, which reflects a part of the light. The remaining part is radiated onto the object surface 13 and/or 14 via the measurement light path M1 through at least one fluid-mounted light transport module of the scan sensor 1.

The large path length difference between the sections M1 and R1 is compensated by means of a path length compensation module 55, which contains a beam splitter plate 56 and a reflector 57. The distance between the beam splitter plate 56 and the reflector 57 is so dimensioned that the optical path length difference between R1 and M1 is compensated by a corresponding optical path length difference between the partial paths M2 and R2 running in the path length compensation module 55.

By means of the optical couplers 48 and 51, the primary light originating from the light source 46 is coupled into both the scan sensor 1 and also the path length compensation module 55. Therein parts of the light are radiated to the beam splitter plates 53 and 56, respectively, and are reflected there. Other light components are transported in the scan sensor 1 to the surface 13 and/or 14 which is to be scanned, and are reflected there or transported to the reflector 57 in the path length compensation module 55, from which they are reflected. The reflected light runs back as secondary light, a component reaching a detection unit 60 via a detection path by means of optical couplers 48 and 51.

Of course, all of these light components can propagate independently on the described light transport paths. The detection unit 60 is implemented, however, in such a manner that it only generates an interference signal if reference light reflected from the reference reflector and measurement light reflected from the surface which is to be scanned are irradiated on the detector in a phase relationship allowing interference. Therefore, only those light components which correspond to the set longitudinal scan position are detected by the detection unit. As explained at the beginning, the scanning position is in the context of the invention preferably not varied by means of a movable reference mirror, but rather by means of a fixed reference mirror in combination with a detection unit 60 implemented according to WO 03/073041, which comprises a wavelength selection device 61 (only symbolically shown here). It allows the function explained in greater detail in WO 03/073041 and summarized briefly above. This document contains numerous further explanations and design suggestions, in particular with respect to other possibilities of performing the longitudinal scan, i.e., the variation of the particular scanning position in the beam direction (longitudinal scan position) in the context of an LCDS method.

FIG. 3 shows a further embodiment of a scanning sensor comprising two fluid-mounted light transport modules, namely a light transport module 2 and a longitudinal-scan module 35. A special feature is that a penetrating section 35a of the longitudinal-scan module 35 penetrates into a corresponding recess of the first light transport module 2. This allows more favorable positioning of the adjacent optical elements (lenses) 37 and 39, respectively, of the two fluid-mounted light transport modules 2, 35. More effective signal transmission is thus possible.

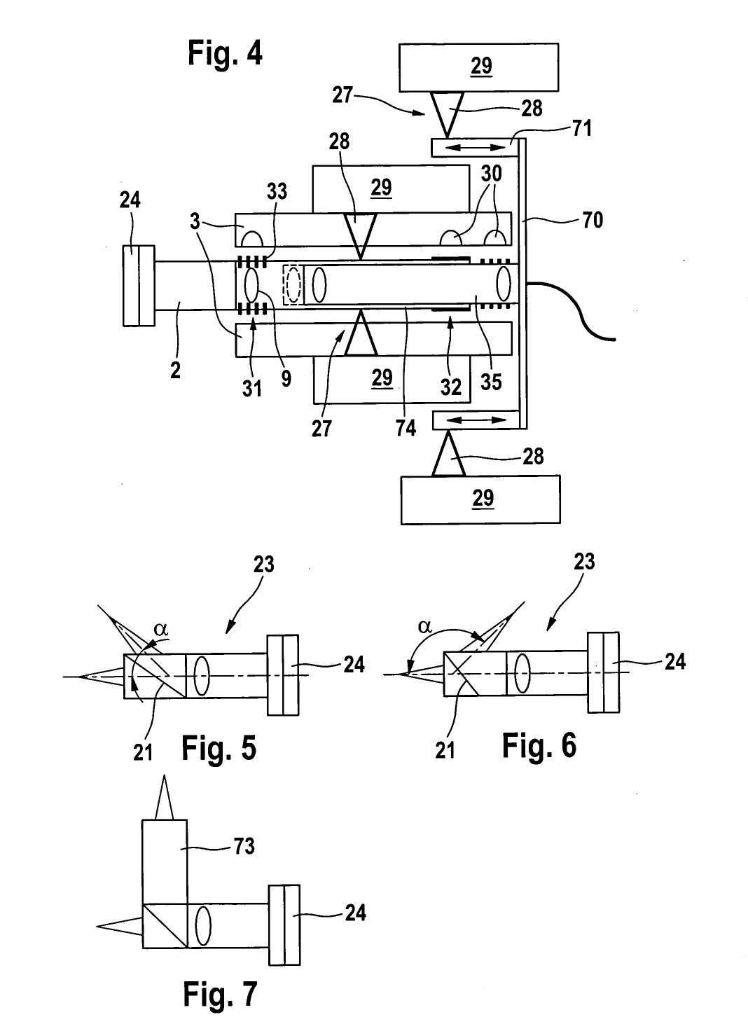

The alternative embodiment shown in FIG. 4 is distinguished by a design which is especially compact in the axial direction. This is advantageous for specific applications, in which the maximum length of scanning sensor in the axial direction is limited. To allow this compact construction, the longitudinal-scan module 35 is in the embodiment shown connected via a flange 70 to drive elements 71 which extend forward from the flange 70 (i.e., in the direction toward the light exit optics). The transport elements 28 act on the drive elements 71 by means of piezo drive electronics 29. This is advantageous if—as shown here—the longitudinal-scan module 35 penetrates so far into the light transport module 2 that no sufficient partial length of its external wall is accessible for the transport elements 28 of the piezo drive. Different designs are possible. The compact construction is achieved by using drive elements, on which the transport elements of the rotation-translation drive 27 act, and which extend in the axial direction forwardly from the rear end (facing away from the light exit optics) of the longitudinal-scan module 35.

A further special feature of the embodiment shown in FIG. 4 is that the longitudinal-scan module 35 is mounted in a bearing gap 74, which is present between the external wall of the longitudinal-scan module 35 and the corresponding internal wall of the recess of the first light transport module 2, into which recess the longitudinal-scan module 35 penetrates telescopically. The longitudinal-scan module 35 is thus not mounted directly, but rather indirectly (via the light transport module 2) within the bearing part 3. Furthermore in this case a rotation of the longitudinal-scan module 35 is prevented by the drive elements 71. It is thus mounted in a rotationally fixed position. Therefore, in the embodiment shown in FIG. 4, a rotational position sensor for detecting the rotational position of the longitudinal-scan module 35 is not necessary.

FIGS. 5 through 7 show three different variants of exit optics modules which are suitable for the invention:
In FIGS. 5 and 6, the beam splitter layer runs at a different angle from FIG. 1, in such a manner that the radial scan occurs at an angle α of 45° or 135°. Of course, further variants are possible. The example shows that the angle of the longitudinal scanning direction may be varied in a broad range.
In the design shown in FIG. 7, an extension part 73 is used, by which the scanning optics may be better adapted to the scanning of rotationally-symmetric surfaces having a relatively large diameter.

Although the light transport modules are movable both axially and also rotating, due to their fluid mounting, this capability does not have to be used in every application. Rather, the invention also extends to scanning systems in which one of the degrees of movement freedom is not required and therefore the first light transport module (carrying the light exit optics) is moved either only axially or only rotating. A translation-rotation drive is also present in these cases, however, which allows the movement with respect to both degrees of freedom. Position sensors for precisely checking the axial and rotational positions are preferably also provided.

In the preceding description, reference was made, with respect to the rotation-translation drive 27 and the corresponding movements of the light transport modules 2, 35, to axial and rotational (transverse to the axial direction) movements. A separation into axial and rotating movement coordinates is helpful in many cases, but is not absolutely necessary. In particular, transport elements 28 which are not specialized for a specific (axial or rotating) movement but rather may be driven electrically in arbitrary spatial directions, may also be used. Of course, the invention also comprises rotation-translation drives of this or similar design, in which the movements driven thereby are not restricted to “axial” and “rotating”, but rather also may run at any arbitrary other angle, so that helical movements of the light transport modules result.

When the above description refers to “parts”, it relates to functional units. Of course, this does not mean that these “parts” must be one-piece. In particular, the bearing part 3 may also be assembled from a plurality of individual parts, such as two half shells.

What is claimed is:

1. Scanning system for scanning the surface (13, 14) of an object, in particular for a coordinates measurement machine, or for a position robot,
characterized in that
it comprises a scan sensor (1) comprising at least one fluid-mounted light transport module (2), the light transport module (2) being enclosed by a bearing part (3) and a fluid being provided in a bearing gap (7) between an external wall (6) and the bearing part (3), the light transport module (2) being mounted by means of the fluid in such a manner that it is movable both axially and also rotating with respect to the axis of the cylindrical external wall,
primary light originating from a light source and entering the light transport module at a primary light entry point (11) is transported through the interior (8) of the light transport module (2) to a primary light exit point (12a, 12b) distal from the primary light entry point in the axial direction, from which primary light exit point (12a, 12b) it is emitted in the direction toward the object surface (13, 14), and
secondary light reflected from the object surface (13, 14), which enters the light transport module (2) at a secondary light entry point (16a, 16b), preferably coinciding with the primary light exit point (12a, 12b), is also transported through the interior (8) of the light transport module (2) to a secondary light exit point (17) distal in the axial direction from the secondary light entry point (16a, 16b) and preferably coinciding with the primary light entry point (11), and
the light transport module can be driven both in the axial direction and also rotating by means of a rotation-translation drive (27).

2. Scanning system according to claim 1, characterized in that the scanning sensor (1) comprises two fluid-mounted light transport modules (2, 35), a second light transport module, guided coaxially with the first light transport module (2), serving as a longitudinal-scan module (35), being movable in relation to the first light transport module in the axial direction, and containing optical elements through which the primary light is transported from a primary light entry point (39) of the longitudinal-scan module (35) to a primary light exit point (40) distal in the axial direction, from which primary light exit point (40) it is further transported into the primary light entry point (11) of the first light transport module (2); and in that light exiting from the primary light exit point (17) of the first light transport module (2) enters the longitudinal-scan module (35) via a secondary light entry point (41) preferably coinciding with the primary light exit point (40) of the longitudinal-scan module and is also transported through its interior to a secondary light exit point (42) of the longitudinal-scan module (35), distal in the axial direction from the secondary light entry point (41) of the longitudinal-scan module (35) and preferably coinciding with its primary light entry point (39).

3. Scanning system according to claim 2, characterized in that the longitudinal-scan module (35) is fluid-mounted together with the first light-transport module (2) in a shared bearing part (3).

4. Scanning system according to claim 1, characterized in that it comprises a low coherence interferometer (45),
primary light originating from the light source (46) is divided into two light paths by means of a beam splitter (48, 51),
a first part of the primary light is radiated as measurement light onto the object and is reflected at a light-reflecting point, which is located at an adjustable scanning position on a scanning path (R, A), and a second part of the light is radiated as reference light onto a reference reflector (53) and reflected there,
the adjustable scanning position on the scanning path (R, A) is varied for performing a longitudinal scan along the scanning path (R, A) and the reflected secondary measurement light and secondary reference light are combined at a beam junction (51) in such a manner that the resulting detection light generates an interference signal upon incidence on a detector (63), the interference signal containing information about the strength of the reflection of the measurement light as a function of the particular set scanning position, and
a partial path (M1) of the measurement light path runs through the interior of one or more fluid-mounted light transport modules of the scanning sensor.

5. Scanning system according to claim 4, characterized in that a variable wavelength selection device (61) is positioned in the light path of the detection light between the beam junction (51) and a detector (63), by which variable wavelength selection device the detection light may be selected as a function of its wavelength in such a manner that selectively light comprising wavelengths which correspond to a predetermined sequence of wavelengths k, preferentially reaches the detector, and different sequences of the wavelengths k can be set for varying the scanning position along the scanning path.

6. Scanning system according to claim 4, characterized in that a partial path (R1) of the reference light path also runs in a fluid-mounted light transport module (25, 35), this partial path (R1) of the reference light path is shorter than the partial path (M1) of the measurement light path running in one or more fluid-mounted light transport modules of the scanning sensor (1), and the scanning system comprises a wavelength compensation module (55) separate from the one or more light transport modules (2, 35) of the scanning sensor (1), for compensating the difference of the partial paths (R1, M1).

7. Scanning system according to claim 1, characterized in that in the at least one fluid-mounted light transport module (2, 35) the primary light and the secondary light are guided by means of free space optics elements.

8. Scanning system according to claim 1, characterized in that a light transport module (2) comprises light exit optics (19), which are adapted for emitting the primary light in the axial and/or radial directions.

9. Scanning system according to claim 8, characterized in that the light exit optics (19) are a component of an exit optics module (23), which may be connected interchangeably to a fluid-mounted light transport module base part (25).

10. Scanning system according to claim 1, characterized in that the fluid, by means of which the at least one light transport module (2, 35) is mounted, is a gas, in particular air.

11. Scanning system according to claim 1, characterized in that the scanning sensor (1) comprises an axial position sensor (31) and/or a rotational position sensor (32) for determining the axial position and/or rotational angle position of a light transport module (2, 35), wherein a location marking (33, 34) is affixed to the light transport module (2, 35) which marking preferably is periodic.

12. Scanning system according to claim 1, characterized in that the rotation-translation drive (27) comprises transport elements (28), which intermittently contact the wall (8) of a light transport module (2, 35) and execute step-by-step movements tangentially to the wall surface in such a manner that the light transport module (2, 35) is moved in the desired direction.

13. Scanning system according to claim 12, characterized in that the transport elements (28) are moved piezoelectrically.

14. Scanning system according to claim 12, characterized in that a plurality of transport elements (8) are positioned distributed on the bearing part (3) in such a manner that the pressure exerted thereby on the wall (6) of the fluid-mounted light transport module (2, 35) is compensated such that it does not cause an interfering radial movement of the fluid-mounted light transport module (2, 35).

15. Scanning system according to claim 12, characterized in that the rotation-translation drive has separate transport elements for the axial movement on one hand and for the rotation of the at least one fluid-mounted light transport module (2, 35) on the other hand.
